(19) United States
(12) Patent Application Publication
(10) Pub. No.: US 2016/0196744 A1
(43) Pub. Date: Jul. 7, 2016

(54) ASSISTANCE SYSTEM FOR AUTOMATED, INTELLIGENT MANAGEMENT OF TRAFFIC REGULATIONS

(71) Applicants: Javad Razmi, Burghaslach (DE); Naser Aghajanzadeh, Teheran (IR); Zahra Razmi, Teheran (IR); Mina Razmi, Teheran (IR)

(72) Inventor: Javad Razmi, Burghaslach (DE)

(21) Appl. No.: 14/912,006

(22) PCT Filed: Apr. 12, 2014
(86) PCT No.: PCT/IB2014/001033

§ 371 Date: Feb. 12, 2016

(30) Foreign Application Priority Data
Aug. 14, 2013 (IR) 13925014000300423

(51) Int. Cl. G08G 1/0962; H04L 29/08; H04W 4/12

(52) U.S. Cl. CPC G08G 1/0962; H04W 4/12; H04L 67/12

(57) ABSTRACT

An assistance system for automated, intelligent management of traffic regulations is a system for surveillance on proper implementation of the traffic regulations in a transportation system, that acts by using hardware already installed on a vehicle and the tags installed on traffic signs and its internal intelligent map that includes all traffic rules with coordinates of applying their extent. The system records all vehicle actions and controls all traffic rules in places which the vehicle passes and in case of violation plays the necessary audio warnings and simultaneously sends the information of the vehicle, violation and license of the violator to traffic police. The system makes turning on and using of the vehicle subject to locating the valid and appropriate license with respect to vehicle type, so that upon entering the vehicle, a person puts the license in specific place and after authentication the system starts moving.

### TECHNICAL AREA

This invention concerns an assistance system for all transportation vehicles, which have motion engines and are available in any transportation system, such as heavy and light vehicles (public, private, military, governmental), motorcycles, trains (railway), vessels and marine structures.

### TECHNICAL BACKGROUND OF THE INVENTION

Current systems of the traffic police of nearly every country attempt to perform the surveillance of traffic rules implementation through its personnel and equipment. It is obvious that one can't supervise all the effective elements of rules even by most intense controlling. The CCTV cameras, radars and speed control cameras, experienced officers and agents; each one supervises the traffic regulations in both direct and indirect way and has the duty of management of the current traffic rules implementation.

As a matter of fact one won't be able to control and supervise every single vehicle movement precisely nor is it reasonable to hire an experienced officer for checking every single vehicle or driver. This accounts for almost all bigger cities of the world.

Some of the traffic offences are due to the lack of driver awareness or due to the lack of knowledge about the rules applied in different places or countries (for different reasons like not seeing the sign or lack of attention to the traffic warnings etc.). A tourist, for example, can hardly be held liable for a violation in another country, whose regulations he did not know or simply could not obey due to a lack of language or cultural knowledge. Eventually, this will keep a tourist from driving in such a place or country. The same accounts for any other person, who is not up to date with current traffic regulations. For example, the young driving learner will certainly feel discouraged to drive a vehicle if he or she does not feel save in applying all the traffic rules, which become more and more elaborate and detailed nowadays. Also a common navigation system will not help much.

U.S. Pat. No. 5,862,511 A discloses an improved vehicle navigation system and method using information from a Global Positioning System (GPS) to obtain velocity vectors, which include speed and heading components, for “dead reckoning” the vehicle position from a previous position. So even if GPS is not available, the navigation system continues to localize the vehicle on an electronic map.

### SUMMARY OF THE INVENTION

One aim of the invention is the automated control of traffic regulations.

Another aim of the invention is the management of the proper execution of the traffic regulations in every moment in time from the vehicle ignition.

Another aim of the invention is the checking of the (driver's) license, the vehicle card, the insurance letter, the inspection report.

Another aim of the invention is the facilitation of fining for vehicle related violations.

Another aim of the invention is the facilitation of the driver control by parents, by institutions or by any other responsible agency.

The inventors found that in general there is often a requirement given for installing intelligent tag systems in various places to keep a multiple of vehicles under control. The authors suggest that general control can be established by embedding all or some of the traffic regulations in the vehicle's internal map with the coordinates of applying area. Hence, by receiving a GPS signal and by a comparison of the coordinates with the processing software an assistance system inside the vehicle can substitute the intelligent tag system.

Furthermore, the inventors found that the need of using hardware in all of the vehicles can be seen as one of the problems of the common tag systems. So far the problem has been approached by adding the computer systems on top of the existing hardware. An assistance system should have the option of integrating a large part of said system into the already available internal computer of the vehicle. Consequently, the additional system hardware is reduced to a card reader, because the existing hardware can be deployed for the assistance system, which greatly decreases implementation costs.

The invention achieves the desired aims and solves the described problems by proposing an assistance system, which comprises a violation information recorder in a vehicle for an automated recording of violation information corresponding to the vehicle, wherein the assistance system is adapted to make the violation information available to a vehicle-external device, in particular a central server, being controllable by a vehicle-external person, such as the owner of the vehicle or the like, or an institution, such as the traffic police, or the like.

All embodiments of the assistance system according to the invention can be carried out in addition to the centralized controlling of traffic regulations by responsible agencies or institutions and keep the vehicle data or driver data, in particular movements of the vehicle and the driver, fully confidential and/or fully encrypted. Only in case of violation warnings, such as audio warnings, are given to the driver and if the rule is violated the assistance system sends the violation case to the traffic police or another institution and issues a fine for the driver if applicable.

The assistance system is intended to notify the driver about traffic rules, such as the speed limits, no stopping, no horn usage, red light, traffic plan, no passing. Due to warnings and declarative signs of traffic police and the urban management systems through audio or other alerts, the driver is very unlikely to violate the rules unintentionally. In case of lack of attention to the corresponding regulation a fine is issued for the driver according to the rules. The amount of the fine may, for example, be deducted online from the bank account connected to the driver's license or from his mobile phone SIM card and transferred to the traffic police bank account.

The assistance system according to the invention facilitates license checking, card checking, insurance letter checking and inspection report checking. Checking all the traffic rules is automated and does not require personal attention. There is even the option to have the fine printed inside the car, which is a very immediate response with a positive learning effect. Also the payment of the fine can be carried out at the moment inside the vehicle, such as a car. Most interestingly, young driving learners will feel encouraged to drive, because they will not need to know all traffic regulations by heart. Also parents will feel inclined to let their son or daughter, who is not experienced in driving, let drive their car, because the parents can have some control remotely.

Advantageously, the assistance system of each vehicle records the information about its own violations automatically and let, for example, the traffic police, the owner of the vehicle or the parents of the driver know. For this purpose the vehicle-external device is controllable by the vehicle-external person, such as the owner of the vehicle or the parents, or an institution, such as the traffic police.

Also other institutions may hold the control of the vehicle-external device, such as ministries, public or private agencies, organizations such as traffic police, police or military forces, insurance agency, emergency medical services, firefighters, municipalities, state registration, freightage services, authorized repair services and others. Also other vehicle-external persons may hold the control of the vehicle-external device, such as a taxi driver, a bus driver or anyone authorized to use the assistance system. The education and management of traffic regulations can be controlled effectively.

Once the vehicle has been ignited, the system starts to control general and public rules of traffic such as appropriateness of the environment lighting with car lights, fastening seat-belt, credit card, insurance card, vehicle card, inspection report, etc. During driving the system senses the environment constantly and obtains the warning and declarative signals from the environment or the vehicle-external device while comparing coordinates of the vehicle with map and applying rules in the area continuously.

In a preferred embodiment the assistance system is adapted to obtain warning and/or declarative information from the vehicle-external device. The vehicle-external device can be implemented as a radio transmitter or a computer with a wireless or cable based network connection, such as an internet connection. The assistance system can obtain the warning and declarative information from traffic police or other responsible agencies and inform the driver about them (i.e. avalanche, landslide, traffic information, traffic limitations, roadside advertisements etc.).

In a preferred embodiment the assistance system is adapted to check traffic rules with functional parameters of a vehicle driver and dynamic parameters of the vehicle when the vehicle is moving, whereby a warning for the vehicle driver is generated, in particular by means of the audio system of the vehicle, in case the check reveals a violation.

In a preferred embodiment the assistance system is adapted to check traffic rules with functional parameters of a vehicle driver and dynamic parameters of the vehicle when the vehicle is moving, whereby a warning for the vehicle driver is generated, in particular by means of the audio system of the vehicle, in case the check reveals a violation. The system may include an intelligent chip, central processor, monitor 109, audio alert, GSM-GPS-GPRS module, printer and central memory, which these circuits are designed in such a way that after vehicle ignition the system will check all the traffic rules with functional parameters of driver and dynamic parameters of vehicle when the vehicle is on or moving and in case of conflict, it can warn via audio systems, Email, SMS etc. If the driver doesn't pay attention the system will issue a fine (by thermal printer system, for example) and simultaneously might notify traffic police. Also all or a subset of the traffic regulations and the coordinates of their applying extent, for all the roads and ways is available on system central memory. The processor is enabled to check the rules, which are valid at the current location of the vehicle and is intended to take a decision. Optionally, at the beginning of setup, every time, the system will inquire from traffic police for an adaptation of major changes in maps and regulations, and if necessary or if there are new regulations and restrictions, the system will update itself and act according to new rules, which are obtained online and applied to the vehicle.

In a preferred embodiment the assistance system is adapted to electronically read the license data of the vehicle driver using a device of the dashboard and ignite the engine of the vehicle in dependence on the validity of the license. Said system can be adapted to store on the chipset the data of license of the person, who wants to drive the vehicle. The license, for example realized as an electronic card, is readable by using the vehicle's dashboard and circuit. In case the license is valid and allowable with respect to type of the vehicle the permission for vehicle ignition is given. Advantageously, the assistance system can avoid the usage of forged or stolen licenses by checking the license electronically.

In a preferred embodiment the assistance system is adapted to check traffic rules and the type of the license in respect to the type of the vehicle. The assistance system is capable to decide about validity of the license type in the road and whether it is allowed to drive with respect to the type of the vehicle and the time of the vehicle movement on the road by reading the information of the license and comparing the information from signs, internal map and vehicle movement coordinates (for example temporal and spatial limitations for heavy vehicles' movement or restrictions of license type B etc.). Typically, based on vehicle type and license type, some restrictions exist, for example, cargo trucks aren't allowed to be driven on some particular roads or during some hours and this requires a proper surveillance. In case there is a violation, the violation is recorded and the traffic police are notified.

In a preferred embodiment the assistance system is adapted to obtain finger print data of the vehicle driver and verify the obtained finger print data with stored finger print data included in the license. It obtains the information of driving applicant finger print and verifies the information of the finger print included in the license according to the information in the database of the allowed people for driving the vehicle (specified by the owner, for example) by the central processor of the vehicle, and in case of confirmation the system will give the permission for vehicle ignition.

Advantageously, the owner or another authorized person is able to introduce authorized drivers already to the system and prevent the vehicle to be operated by unauthorized people. The validation of a driver's license is fast and thorough and hence much more reliable than checking the license by a police officer. The assistance system can be adapted to inquire from traffic police about the license, and in this way stolen licenses will be recognized and voided easily on the spot. The possibility of using a forged license will come closer to zero.

In addition the assistance system is able to provide the owner to put authorized persons on a specific schedule for using of the system, this means for example the driver number 1 is authorized to drive from 16:00 to 22:00 hours on Sundays or 20th day of every month or different schedules.

Accordingly, a vehicle robbery will be very difficult and in case of operating the vehicle, in any way, the information of the thief will be recorded in the system. Also this system provides the optional facility for parents to control the usage of the vehicle by their children, whose movements and behavior is controlled or managed during driving. Corresponding information is sent to the parents by the assistance system.

In a preferred embodiment the assistance system is adapted to check the validity of the car insurance by an automated, preferably online, request to an institution upon vehicle ignition. While requesting for ignition, the vehicle checks the validity of the insurance card, vehicle card and/or vehicle inspection report by obtaining the information from insurance company or inquiry from traffic police and then gives the permission for driving. The system has the capability to obtain this information online and/or once during the validity period of the insurance card etc.

For example, when requesting for ignition, the vehicle checks the validity of the insurance card, vehicle card and vehicle inspection report by obtaining the information from insurance company and inquiry from traffic police and then gives the permission for driving. The system has the capability to obtain this information online or once during the validity period of the insurance card etc.

In a preferred embodiment the assistance system comprises a reader device adapted to read information from traffic signs and recognize traffic rules to check for possible violations. The reader device is capable to read the information of any tag or information on traffic signs along the roads, bridges, tunnels, barriers etc., and the internal modules of the device read the data of speed and other internal parameters of the vehicle and verify them with obtained information of the road. In case of any discrepancy the assistance system gives the necessary warning(s) and if the driver pays no attention to the notifications, records the violation and sends it to traffic police and/or other responsible agencies (together with information of vehicle and license of the vehicle driver). Recording the traffic violations during the violation and fine instantaneously does not require any natural person in the process and is hence very effective. Controlling the traffic rules like speed, even-odd plan, traffic plan, extent of no stopping, passing a red light and all of the warning and declarative signs of traffic police will be repeatedly carried out.

In a preferred embodiment the assistance system is adapted to receive information from approaching trains in order to generate a warning for the vehicle driver. Like this the assistance system is capable to prevent from accidents by means of received information from the train at level crossings (or other vehicles).

In a preferred embodiment the assistance system is adapted to check traffic rules by taking current coordinates of the vehicle into account. The vehicle is equipped with a printer, a board and a processor that evaluates all the rules with current coordinates of the vehicle instantaneously and plays its specific message via an alarm immediately after the violation. If the driver pays no attention it records the violation in the name of the license holder/vehicle owner and issues a fine.

In a preferred embodiment the assistance system is adapted to recognize a marked area and an allowance status of the marked area based on additionally supplied data. The assistance system is capable to check the places or areas, which have been marked or defined as odd-even traffic or buses' special line or traffic plan by order of traffic police, by means of information received from intelligent chipsets of traffic signs or the intelligent map embedded in the system's memory. If the vehicle does not have a positive allowance status on such a marked area, a violation has been committed and a fine is issued and traffic police is notified.

In a preferred embodiment the assistance system is adapted to prevent a person having committed a violation from driving or moving the vehicle. According to determination of limit of traffic penalties for each person or each vehicle, the system is capable to prevent person driving/vehicle moving who/which violates this limit or inform the police about location of the offending vehicle. A possible measure to prevent a person or a driver from driving or moving the vehicle is to disallow the ignition of the vehicle after the driver has properly parked the vehicle and stopped the engine.

In a preferred embodiment the assistance system is connected to a vehicle alarm system to take a warning measure, such as send a warning SMS or initiate a phone call. The assistance system has the capability to connect to the vehicle alarm and call the (emergency) numbers stored in its memory or send a warning SMS when an alarm is communicated by using a GSM and/or GPRS module. Advantageously, the system is controllable in both, centralized way or decentralized way via SMS (Short Message Service) and/or any other GPRS-GSM system (GPRS: General Packet Radio Service; GSM: Global System for Mobile Communications), and the owner can control some or all facilities of the vehicle by using his mobile phone or any type of GPRS signal transmission. During a vehicle robbery the vehicle, in particular car, can be controlled by entering the password and/or other user information to stop the engine or cause other actions.

Circuits of the assistance system may be designed in such a way to give the system data to the traffic police as centralized and give them to the person's parents or the owner as decentralized. The use as a centralized system and a decentralized system simultaneously in vehicle data transmission is most convenient.

In a preferred embodiment the assistance system is adapted to intelligently observe the traffic and record violations of other vehicles to take preventive steps, such as warn the other vehicles for too fast or too slow movement. The system is capable to observe the road intelligently from its own control center and can warn other vehicles, which are moving slowly without reason, change the line too sudden or increase the speed unexpectedly, and issues a fine if necessary.

In a preferred embodiment the assistance system is controllable in a centralized and/or a decentralized way. The assistance system can be controlled in both, centralized way and/or decentralized way by using of SMS and/or a GPRS-GSM system. Optionally, the driver or the owner can control all or some of the vehicle features by using his mobile phone or any type of GPRS signal transmission. During a vehicle robbery, for example of a car, he/she can turn off or control the car by entering his/her own password and/or other user information. Advantageously, circuits of the system are designed in such a way to pass system data to the traffic police (centralized way) and give them to the person's parents (decentralized way).

In a preferred embodiment the assistance system is adapted to immobilize the vehicle in case of a violation. Depending on request and with respect to the traffic officer's opinion, the system can act like some locks, which are attached to the wheels for keeping the vehicle, in particular cars, stationary. By order of the traffic officer, the lock signal is submitted for remotely activating the lock function. In these cases all the information may be recorded on a traffic police system. Optionally, the driver or the owner is/are informed about the locking and unlocking of the vehicle/car by order of the traffic officer—without the need of additional metal hardware.

In a preferred embodiment the assistance system comprises an encrypted internal memory for the storage and recording of finger print data and license data. The assistance system has an encrypted internal memory for storage and recording of information of finger print and valid licenses for driving any type of vehicle in both centralized way (inquiry from traffic police) and decentralized way.

In a preferred embodiment the assistance system is adapted to be in touch with an institution, such as an insurance agency. The assistance system is capable to be in touch with insurance system by using an embedded chipset and inform the driver about a validity status of the insurance letter or make some changes to it, such as an extension of the insurance letters or a request of a new insurance letter.

In a preferred embodiment the assistance system is adapted to communicate with the institution, such as contacting the insurance agency and take action for the insurance validity extension on time. The assistance system can stay in touch with insurance system by using an embedded chipset and inform the driver about the insurance validity period or take action for its validity extension in proper time.

In a preferred embodiment the assistance system is adapted give notice of the warnings visually or acoustically. The assistance system is capable to display the information of its warnings visually on a monitor for the drivers, who are deaf or hearing impaired. Alternatively, the warning is declared using horns on the side of the vehicles. Additionally, the system also declares the information about horns of the side vehicles visually for the driver by its microphone sensor.

In a preferred embodiment the assistance system is adapted to notify the driver regarding the vehicle information and the information obtained from the road to prevent violation. The assistance system notifies the driver regarding to the vehicle information and the information obtained from the road (such as maximum height or weight of vehicle) and prevents from violation. Obtaining the information of allowed height and weight for the road in accordance with traffic police's opinion from internal map of the vehicle is most advantageous.

In a preferred embodiment the assistance system, in particular the vehicle-external device, is adapted to supply data access to the vehicle-external person, such as a driver of a bus or taxi or other authorized persons, and/or to the institution, such as a ministry, public or private agency, traffic police, police, military forces, insurance agency, emergency medical services, firefighters, municipality, real estate registration, freightage services or repair service. A part of this system can be left to the disposal of ministries, public and private agencies and organizations such as traffic police, police and military forces, insurance agencies, emergency medical services, firefighting, taxi, bus, municipalities, real state registration, freightage services, authorized repair services and others, who ask to use this system. It is possible to make regular and periodic reports as textual, schematic and spreadsheets on related menus and sending it to the person's or institution's E-mail. Also the system may be able to controlling all the required facilities, service selling, system's software and database updates, traffic plan management and selling, vehicle parking places etc., sending coordinates and complete information of an accident scene and full description of report with coordinates and speed and dynamic parameters of the vehicle before and at the accident time as well as images and the traffic officer's report for insurance companies, road assistance vehicles, traffic police and other authorized organizations.

Additionally, the assistance system is subscribed at car pricing centers and through a connection of the vehicle transmit information such as distance travelled, average movement on roads, average movement in cities, average movement in villages, average speed, average speed in streets, average speed in roads, report of changing main parts of engine, accident reports, accumulative report of vehicle offences and all the information that effects on price of the car to the experts. Also, the assistance system can be adapted to price the vehicle by using of its advanced internal algorithms based on artificial intelligence based techniques, car manufacturer information, its general system and the data of physical observations by the experts.

In a preferred embodiment the assistance system, in particular the vehicle-external device is adapted to void the vehicle inspection report when an accident happened. The assistance system is enabled to void the vehicle inspection report when an accident happens if necessary. Optionally the system may get active to reserve time and place for a vehicle inspection. The automatic voidance of the vehicle inspection report during accidents or according to traffic officer's order saves much time and is hence advantageous.

In a preferred embodiment the assistance system is the assistance system is adapted to recognize the speed limit and compare the vehicle speed to the recognized speed limit. The assistance system can recognize the speed limit in respect to the read information from the traffic sign reader or the internal map and process it regarding to its own speed. In case of violation, the system stores the report of the violation and notifies the traffic police about that. Optionally, the owner can be informed via systems of audio warning, SMS, E-mail etc.

In a preferred embodiment the assistance system is adapted to notify the driver about speed limits and warning and declarative information of the road when entering the road. The assistance system is able to notify the driver about speed limits and all the warning and declarative information of the road when entering the road and reading the traffic signs. Also a derivation of the traffic information (warning/declarative) from vehicle's internal map is most useful in this context.

In a preferred embodiment the assistance system is adapted to recognize the coordinates of a traffic light and to access traffic light information. The assistance system is capable to recognize coordinates of the crossroad and if the traffic light is red, receive the information submitted by the traffic light. If the driver violates (crossing the traffic light in red) issues a fine.

Advantageously, the assistance system receives the time period of red light by receiving a signal from the traffic light and displays the signal to the driver. Also depending on request or if the time extends or changes, the assistance system can display the information of the traffic light on the vehicle's monitor with new updated information. At a red traffic light the system may be enabled to allow right-turns and left-turns by receiving the coordinates and direction of vehicle movement and distinguishing the road and entry path, and to issue the permissions easily for being allowed right-turn when the traffic light is red. Also vehicles confirm reception of the signal by sending a signal back to the traffic light. This way another system installed on the traffic light is able to obtain information of the rate of vehicle accumulation at red light, and choose the time periods of the red, yellow and green lights or status of them accordingly. Alternatively, the system of the traffic light sends the information of vehicle accumulation to the traffic control center.

In crossroads, the vehicle can realize being located in traffic light area by means of an internal map and obtained coordinates from GPS module, and when the light is red, it sends an encrypted signal to the around vehicles' system that means the light is red and if the driver pays no attention and move, the system records the violation. In addition the system is able to distinguish the right-turn from crossing the red light via chipsets installed on allowed right-turns of the crossroads or by means of the information of the map, and consider it as allowed move, and also can warn about stopping in turning area as an offence and record it.

In a preferred embodiment the assistance system is enabled to distinguish places of no entry from places with allowed access. The assistance system distinguishes places of no-entry or of no-stop etc. via traffic signs or the coordinates in the map, and also maybe with respect to the coordinates obtained from its navigator. If a violation occurs the driver is notified and in case of a violation of that rule a fine is issued. The same applies when there is an area of no parking, a bus stop, along the road, or a squares etc.

In a preferred embodiment the assistance system is adapted to disable reverse gear in dependence on the road type. The assistance system identifies the road and in case of using of reverse gear on a highway or speedway, records the violation. The assistance system identifies the type of the road or the way the vehicle is moving along and then is capable to determine the road to be a one-way as well as the direction of the vehicle movement and if there is a violation the corresponding warning is issued. In case of lack of attention on part of the driver the violation is recorded.

In a preferred embodiment the assistance system is adapted to apply regulations of special vehicles, such as taxi or bus, by identifying the vehicle type and the license type. The system is capable to apply regulations of special vehicles (e.g. taxi, bus etc.) by identifying the vehicle type and licenses of people. The automatic comparison of specific rules based on license and vehicle type is most effective.

In a preferred embodiment the assistance system comprises an intelligent cruise control enabled to declare the allowed speed and the distance to the vehicle in front. The assistance system is capable to calculate the distance to the vehicle in front by connecting the intelligent system of the vehicle to a radar device or sensors. In respect to the type of the vehicle a decision about the duration of movement is made (day or night may be different) and also the road type in case of the allowed speed may be considered, including the safe speed and distance to vehicle and possible barriers in front. If the vehicle/driver has committed a violation a fine is issued or the traffic police station is informed. Advantageously, the system can declare the allowed distance and/or the recommended speed to the driver to facilitate the decision making of the driver for adjusting the speed and distance to vehicle in front.

In a preferred embodiment the assistance system is adapted to warn the vehicle driver or other passengers of the vehicle if the seat belts are not fastened. The assistance system is capable to warn the moving vehicle if a seat belt isn't fastened by the driver or other passengers of vehicle according to the related regulations at the coordinates. In case of lack of attention a fine issued.

In a preferred embodiment the assistance system is adapted to record the driving time and to recognize driving times exceeding the allowed time. The assistance system is capable to recognize when the driving time has exceeded the allowed time according to the law for the public vehicles or any type of vehicles to prevent a violation. If an image of the person has been stored in the license, the assistance system may also be able to compare it with the live image received by a camera to prevent license fraud. The system gives the information about the violations to the traffic police.

In a preferred embodiment the assistance system is adapted to communicate the last vehicle driver to the owner of the vehicle or to the institution, such as the traffic police. The assistance system is capable to identify the last driver and in case of violations, which are subject to fine a traffic officer in person, in particular, if the driver isn't present at violation place. The related information is passed to the traffic officer via embedded transmitter and a signal, which is encrypted by public or private key. The violation is recorded in the name of the driver or the vehicle. Furthermore, the system is able to communicate all the movement events of the driver or the vehicle such as speed and movement directions, from beginning of travel time or before that and or of some latter travels depending on request. This matter can be used when the vehicle is stopped by traffic officers or during an accident etc.

Advantageously, the system is capable to identify the last driver and inform traffic police about the related information by sending an encrypted signal to the part of the system that is accessible for traffic officer. In case of violations, where the driver isn't present at stopping place, the system notifies the driver by sending warning SMS or a notification about penalty or vehicle detention (for example for offences like no stop or during carrying by crane).

In a preferred embodiment the assistance system is adapted to send driver related information to the vehicle-external device. The assistance system is capable to identify the last driver and inform traffic police about the related information by sending an encrypted signal to the vehicle-external device, which represents a part of the assistance system that is accessible for traffic officer. In case of violations, where the driver isn't present at stopping place, the system notifies the driver by sending a warning SMS or a notification about penalty or vehicle detention (for example for offences like no-stop or during carrying by crane).

In a preferred embodiment the assistance system is adapted to record the coordinates of the vehicle along with the distance travelled and compares the current coordinates at ignition with the last recorded coordinates before ignition for conflicts. If a conflict is found the assistance system enters the towing determination or unauthorized interruption state. The internal circuits of the system are designed in such a way to record the coordinates of the vehicle with distance travelled and compare this information with information of the vehicle ignition moment and if there is a conflict (of course by considering a balanced coefficient) the system goes into the towing determination or unauthorized interruption state. When vehicle crashes for any reason, it must be moved by the authorized tow vehicles to the parking or authorized repair services (or the offences which causes the vehicle movement by a crane). These vehicles will give the permission to their own systems for position changing, while igniting again by obtaining information of the vehicle registration plate and its password, otherwise the system records the violation of unauthorized towing for the vehicle. Also this can prevent the assistance system of the vehicle to turn the vehicle off or to demobilize it, because if it is reconnected, the system is faced with changes in vehicle distance travelled and in coordinates, and may unfortunately send the information of the vehicle as a violator to traffic police.

In a preferred embodiment the assistance system is adapted to ensure that snow chains are connected to the vehicle. The assistance system is capable to insure that the snow chains are connected to the vehicle via a chipset that designed for snow chains, and in the roads where using of snow chains is mandatory (with respect to the time of obligation to use), and if the driver doesn't use the snow chains gives necessary warnings and in case of lack of attention records the violation and gives the information of the vehicle to traffic police for stopping it.

In a preferred embodiment the assistance system is adapted to classify and declare violators at selected locations, such as a police station or a toll collection point. At special places like a police station or a toll-collection point, a specific classification of violators and passing vehicles will be carried out. The vehicles of the violators of the traffic regulations can be classified and declared to the related police station (e.g. roadside billboards).

In a preferred embodiment the assistance system is adapted to recognize a toll-collection point 335 as such via GPS, GPRS or GSM and initiate the toll payment. The system is capable to distinguish being at toll-collection points via GPS, GPRS or GSM, and pay a toll through its own payment system without the need of any installed physical structure at the toll-collection gate or any personnel. The toll payment without any local hardware as well as the recognition of the toll-collect point is most effective and advantageous.

In a preferred embodiment the assistance system is adapted to pay tolls and/or traffic fines online via the internet or the mobile phone credit. The assistance system is capable to pay the traffic fines online, periodically or at a specific time by using of the bank account connected to the license as well as mobile phone credit and issue the receipt, or control the municipal services, daylight traffic plan, ticket reserving, park meter etc.

Advantageously, the system according to the invention is applicable in nearly all moving transportation systems (i.e. transportation, public, private, railway, marine, etc.). The embodiments as described in the figures refer to the special case of vehicles to be public cars. However, the invention is not limited to said embodiment nor any other discussed in the following.

### SHORT DESCRIPTION OF THE FIGURES

FIG. 1 shows an assistance system components diagram of the device installed on the vehicle,

FIG. 2 shows an assistance system flow chart,

FIG. 3 shows an assistance system performance diagram,

FIG. 4 shows the electrical connections of an assistance system processor, such as the CPU 105 of FIG. 1,

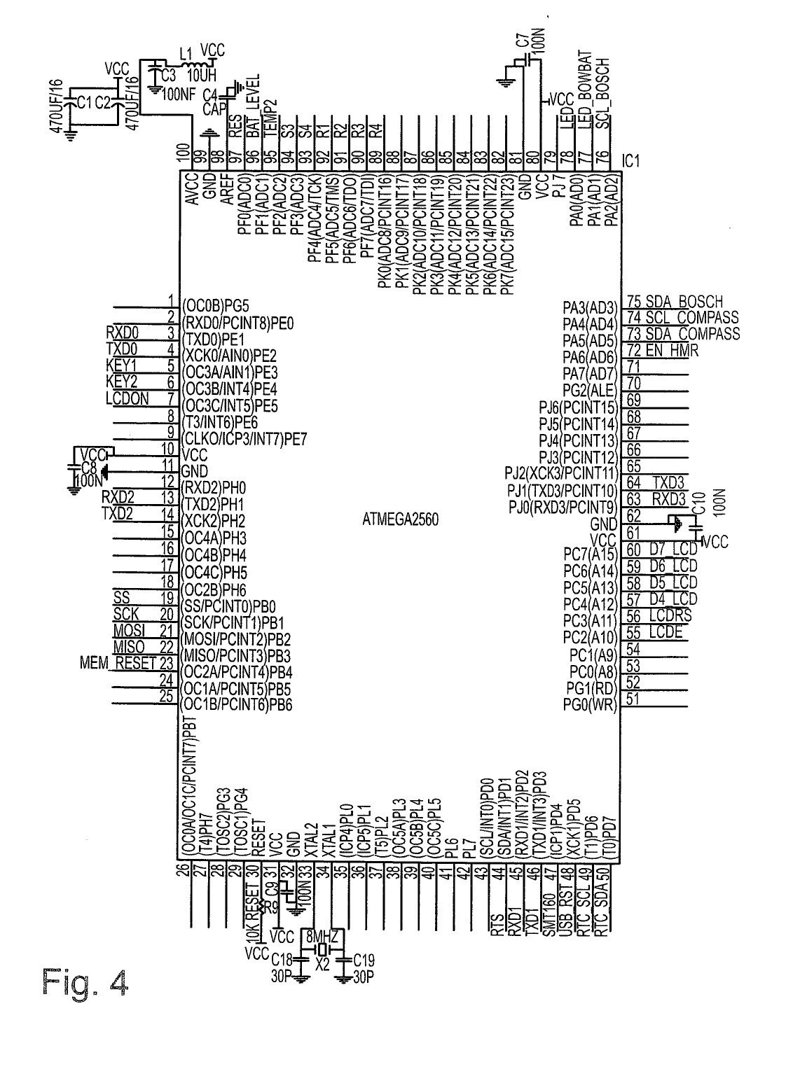

FIG. 5 shows a plan of Universal Serial Bus (USB) connections to connect modules and devices to the assistance system,

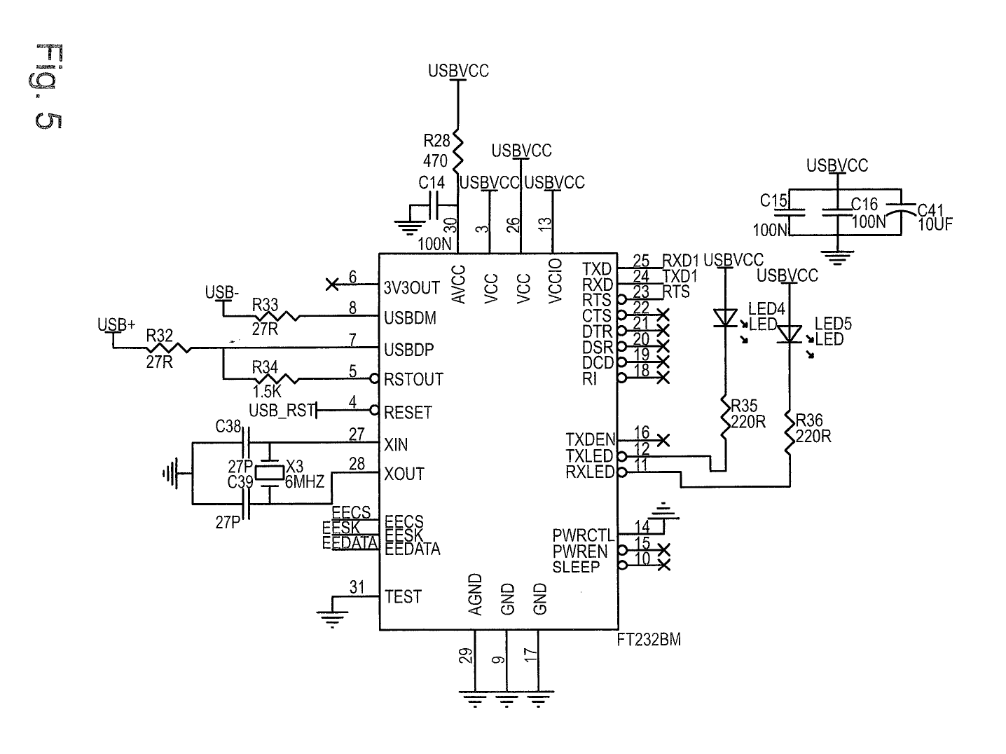

FIG. 6 shows communication links of the assistance system,

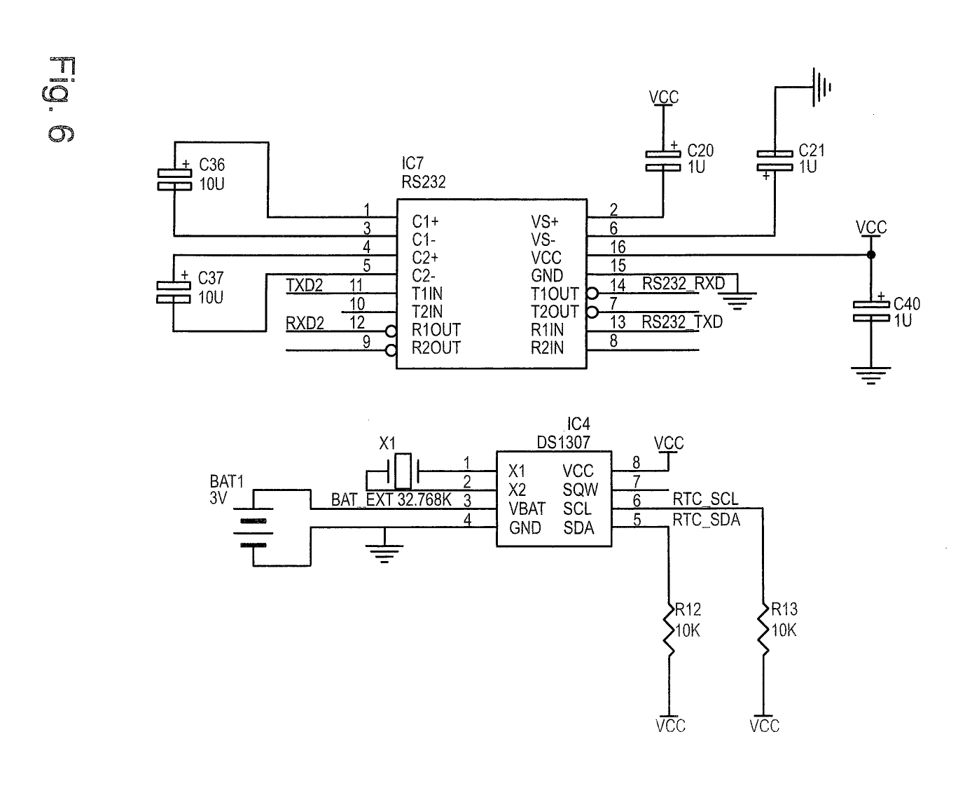

FIG. 7 shows electrical circuits of a GPS and GPRS module, such as the modules 103 and 106 of FIG. 1, respectively,

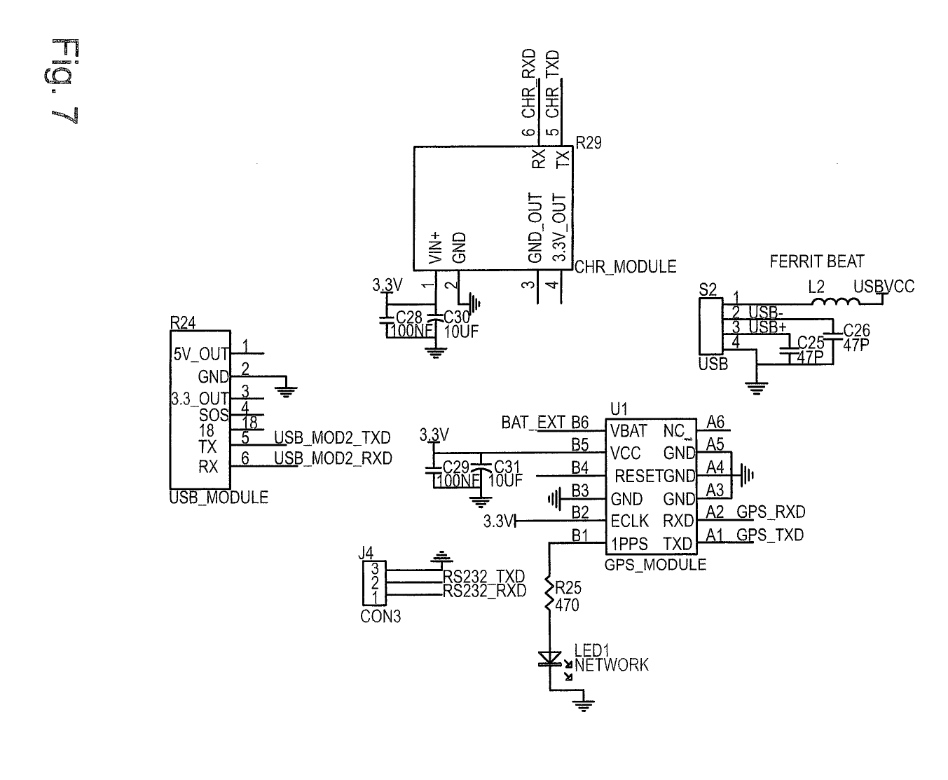

FIG. 8 shows electrical connections of the graphical display, such as the monitor 109 of FIG. 1,

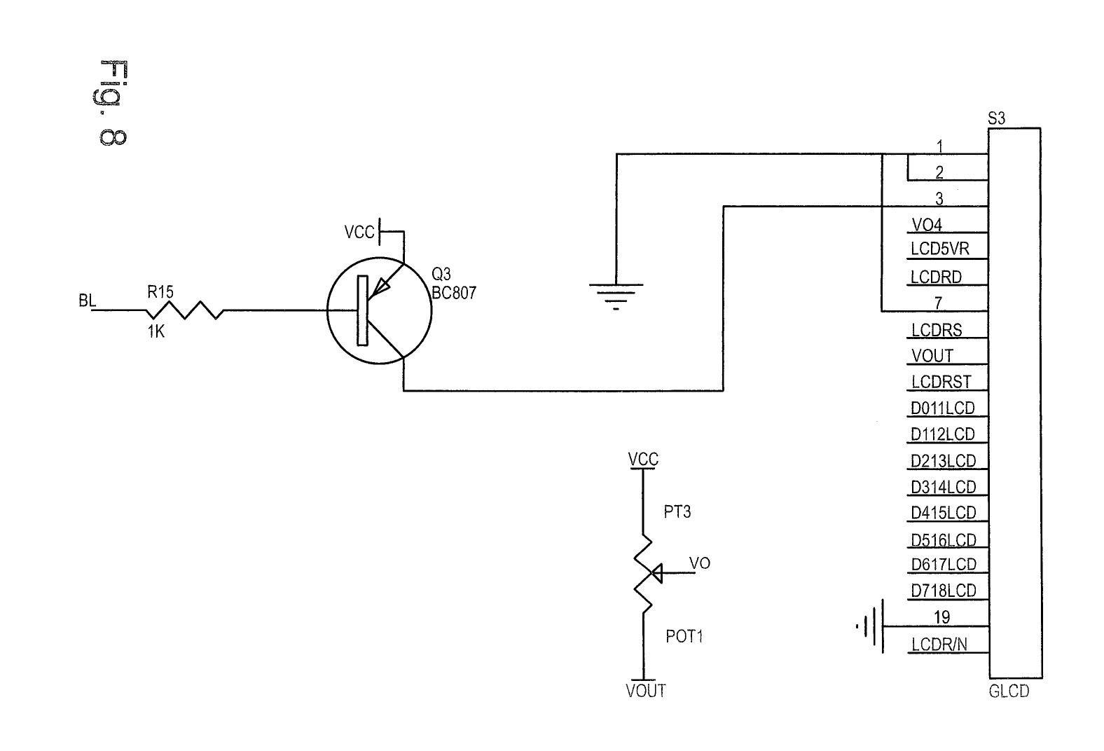

FIG. 9 shows programmer electrical connections,

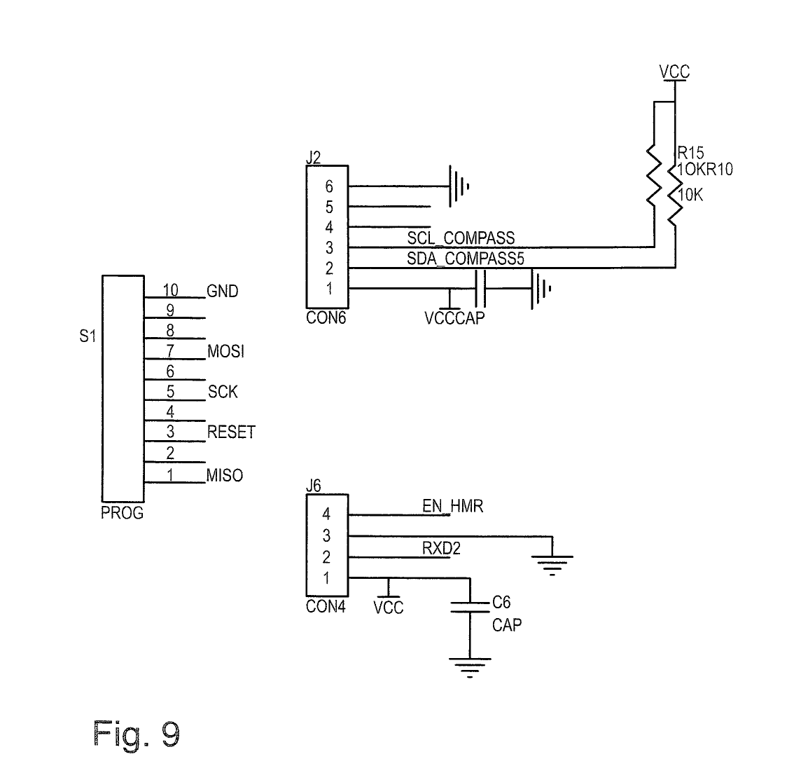

FIG. 10 shows a power circuit for the power supply 102 of FIG. 1,

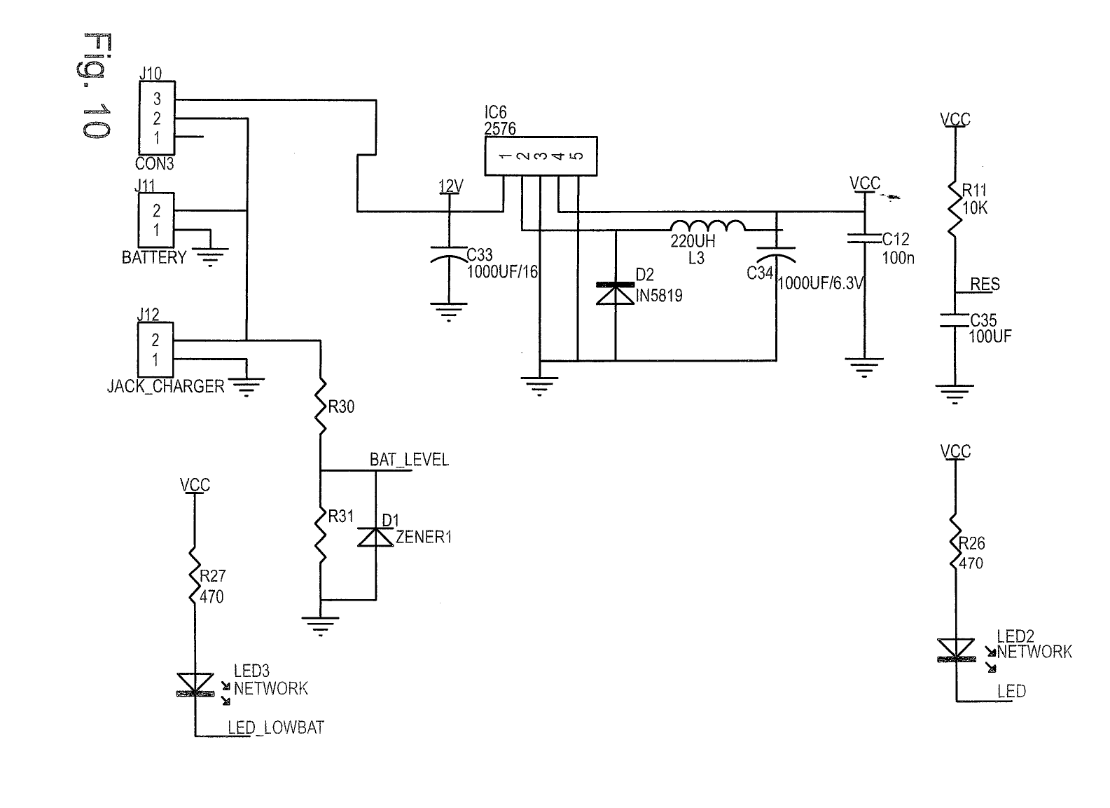

FIG. 11 shows communication connections, and

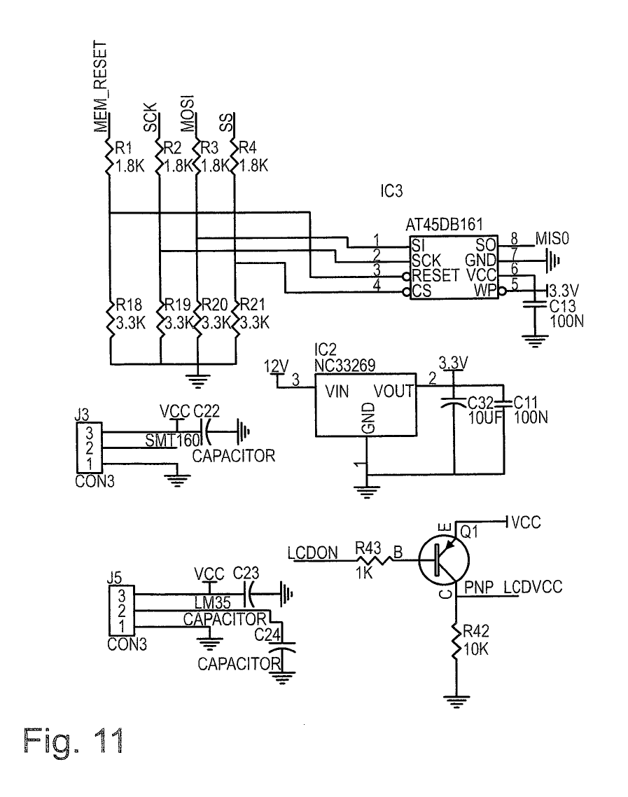

FIG. 12 shows circuits of a fingerprint verification module, such as the fingerprint sensor 107 of FIG. 1.

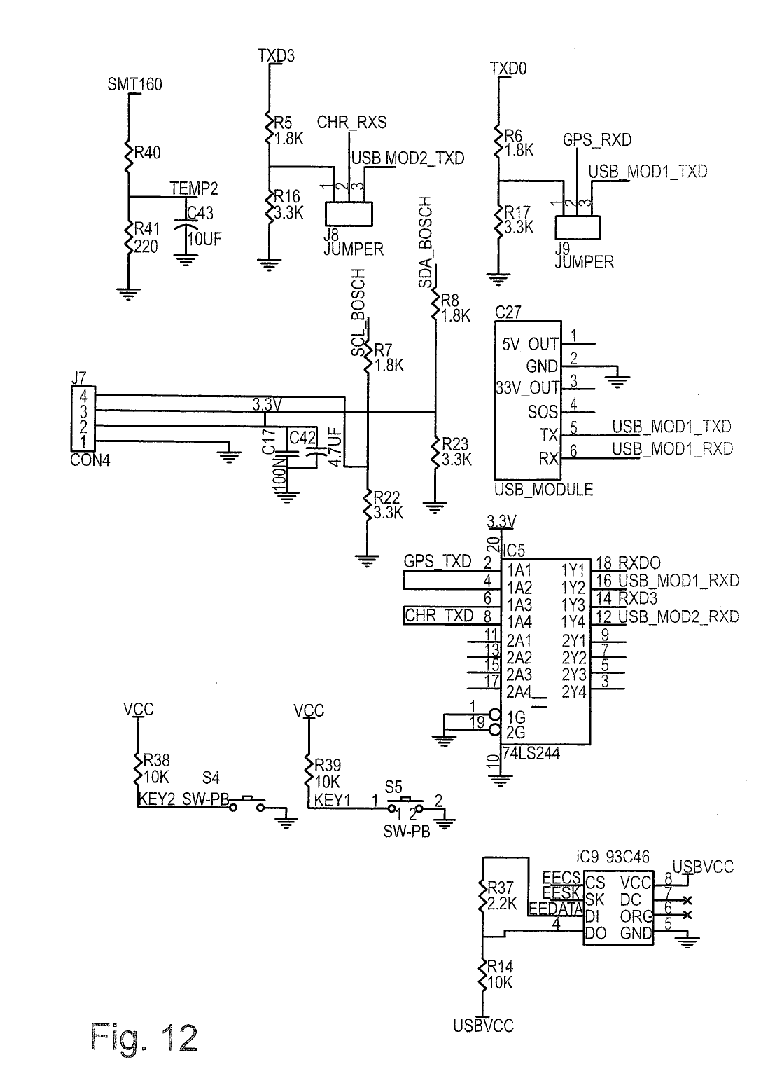

### DETAILED DESCRIPTION OF THE FIGURES

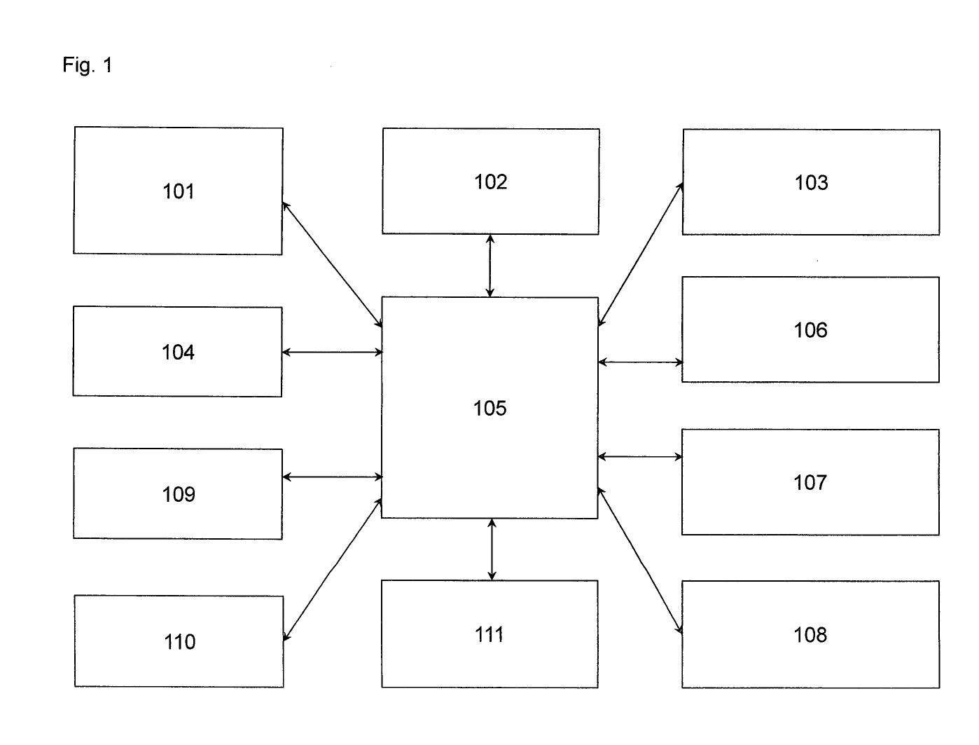

FIG. 1 shows schematically an auto-control intelligent management of traffic regulations system, which is an integrated system for education and management of the traffic regulations and is referred to as assistance system or even more simplified as “the system”. Its performance can be described as: when requesting to use the vehicle at first the license of the person is located in the device and is authenticated, then fingerprint of the person is located in the device and is compared with the fingerprint stored on the license, if it is valid and if the license is correct and the fingerprints of the driver and license holder are the same, the system gives the permission of vehicle ignition and the vehicle will be operated.

The central processing unit 105 is the CPU of the assistance system in a vehicle. Advantageously, the assistance system shares the CPU 105 with the board computer of the vehicle, which is adapted to control vehicle functions, such as operational checks on the engine or the like.

The driver may speak to the assistance system and supply information or commands with spoken language, the assistance system comprising the speech recognition software or module. The microphone 104 picks up the audio input coming from the driver or the passengers. Another data input comes from the fingerprint sensor 107, which is also connected to the CPU 105.

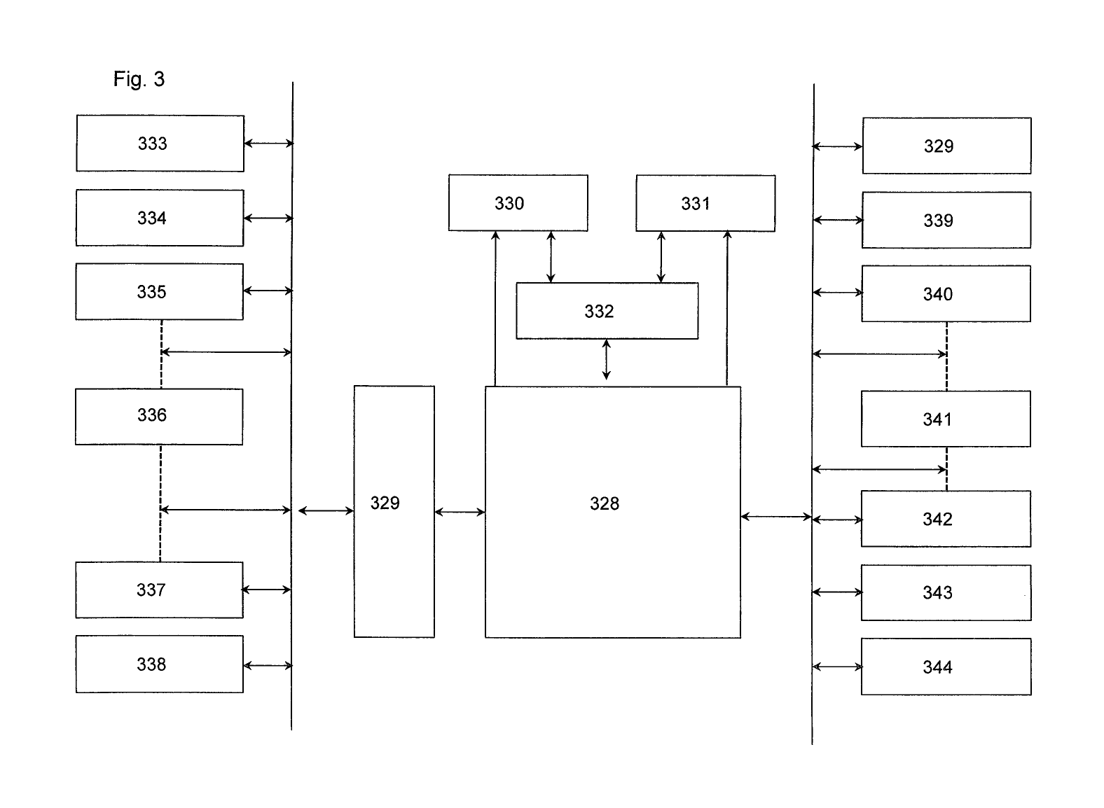

The antenna 111 is intended to communicate with system devices on the road such as traffic lights or other traffic controlling devices. The GSM-GPRS-G3 Module 106 is intended to get in touch with the traffic police 329 or an insurance agency 339 (FIG. 3). Other wireless interfaces may be appropriate as well, such as Bluetooth to get in touch with the driver's mobile phone or other electronic device containing a computer or electronic storage. The driver's license can be inserted as a smartcard into the smartcard reader module 108. The data on the smartcard can be crosschecked with the fingerprint data from the fingerprint sensor 107 and if the fingerprints coincide the ignition is authorized in case the license type is appropriate for the vehicle.

The speakers 101 and the monitor 109 are used to pass directions, declarative information and warnings to the driver acoustically or visually, respectively. Also the printer can print such information and warnings and, in particular, print fines.

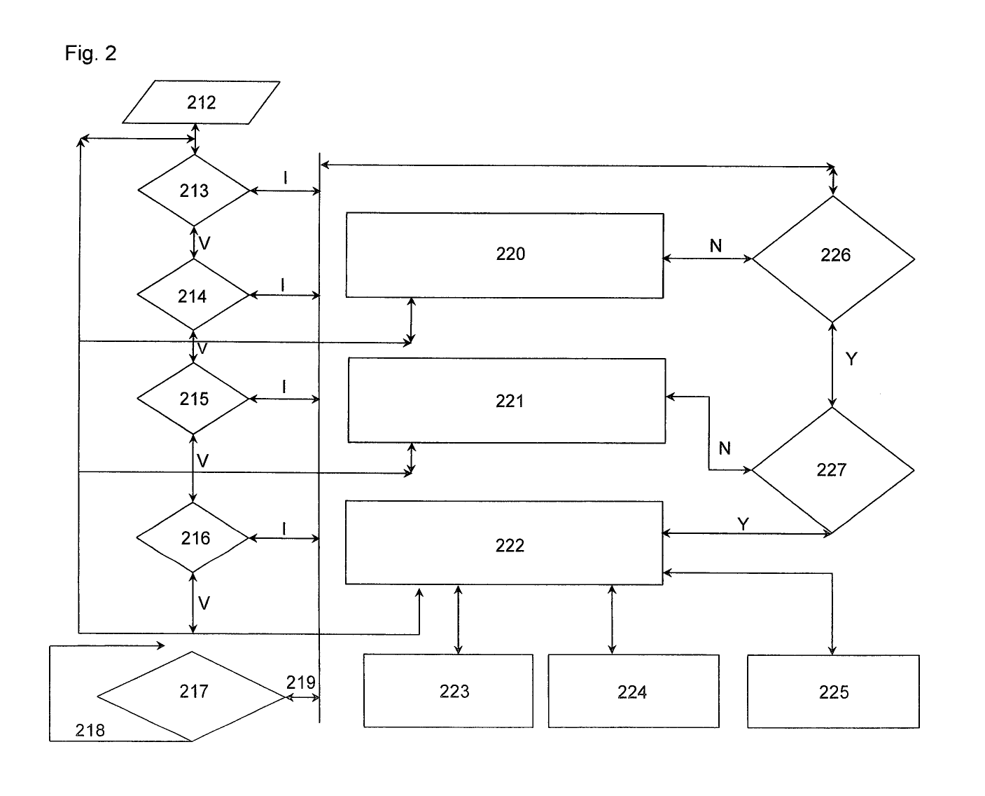

FIG. 2 shows a possible flowchart of the assistance system operational mode. At the start 212 the driver begins the admission process with an inquiry of the vehicle card 213 and if the system considers the vehicle card invalid, the process is stopped without ignition. The inquiries 214, 215 and 216 are cascaded and are treated the same way. There is only an ignition of the engine, once all inquiries are confirmed valid.

The assistance system constantly checks the performance of the driver in the comparison check 217 of each performance 218, which together constitute a constantly worked loop. The loop ends once the driver shuts down the engine, stops performing or if the performance 218 is found to contain a violation 219. In case of violation 219 the warning procedure is initiated.

If a violation 219 is found or an invalid inquiry was detected, the first warning 220 is given if it was the first time 226. Accordingly, the second warning 221 is given when it is the second time the violation 219 or invalid inquiry was recorded or ignored by the driver. Eventually a fine 222 is issued via one of the three options 223,224,225.

FIG. 3 shows the assistance system performance diagram and how the system is connected to persons and institutions. The owner 330, the driver 331 interact with the device 332 installed on the vehicle. The device 332 is the part of the system, which is displayed with most of its modules and components in FIG. 1. The owner 330, the driver 331 and the device 332 are communicating with a central server 328, which constitutes in this example the vehicle-external device 328.

The police have access to or even control over the central server 328 and hence can get informed about violations via the device 332 or can deliver new traffic rules to the device 332, which are stored and implemented.

The owner 330 is able to introduce authorized drivers 331 already to the system and prevent the vehicle from being operated by unauthorized people. In this way vehicle robbery will be very difficult and in case of operating the vehicle, in any way, the information of the thief will be recorded in the system.

In addition the system is able to provide the owner 330 to put authorized persons on a specific schedule for using of the system, this means for example the driver 331 number 1 is authorized to drive from 16:00 to 22:00 on Sundays or 20th day of every month or different schedules.

Also this system provides this appropriate facility for parents to control using of the vehicle by children that their movements and behavior are managed during driving and is sent to their parents by the system.

After the system has been ignited, the system will control general and public rules of traffic such as appropriateness of the environment lighting with car lights, fastening seat-belt, credit card, insurance card, vehicle card, and inspection report, no cell phone use while driving, etc. and during being driven by the person, senses the environment constantly and obtains the warning 220,221 and declarative signals from the environment and compares coordinates of the vehicle with map and applied rules in the area continuously, for instance when entering a highway, it checks the highway entry sign and if the person's license isn't allowed to enter the highway, alarms or issues a fine. When the system observes the speed sign in the highway, it immediately records the speed limit for driving on that road and controls the vehicle's speed constantly. It can notify the driver 331 about his or her speed or in case of not paying attention to the warnings 220,221, issue a fine or inform the police 329 or nearest toll-collection point and centralized traffic control system.

This process is repeated for other traffic rules like even-odd plan, traffic plan, no stopping areas, traffic lights and all the warnings 220,221 and declarative traffic signs. Moreover, based on vehicle type and license type, some restrictions will be made, for example cargo trucks aren't allowed to be driven on some particular roads or in some hours and this requires a proper surveillance.

In crossroads, the vehicle can realize being located in traffic light area by means of internal map and obtained coordinates from GPS module 106, and when the light is red, it sends an encrypted signal to the surrounding of the vehicles' system indicating that the light is red and if the driver 331 pays no attention and moves on, the system records the violation 219. In addition, the system is able to distinguish the right-turn from crossing the red light via chipsets installed on allowed right-turns of the crossroads or by means of the information of the map, and consider it as an allowed move, and also can warn about stopping in turning area as an offence and record it.

The system observes and applies the traffic regulations in two conditions: In first condition, all the rules are located as tags on signs and specific places, and the vehicle realizes them immediately after seeing and applies the rules.

In second condition, the system has a full map of the whole country with all the traffic rules and recognizes at which point of the map it is located by means of the coordinates received from GPS module 106, and which rules are applicable at that point. In this way, all the traffic signs are virtually available on the map and the system will read them out to the driver 331 immediately after seeing and crossing them and if necessary issues a fine.

The system has the capability to inquire from traffic police 329 about the license, and in this way stolen licenses will be voided easily and the possibility of them to be forged will come closer to zero.

This system has been designed in such a way that the data on the chipset of the license of the person, who wants to drive the vehicle, is read by using the vehicle's dashboard and circuit, and if the license is valid and allowed with respect to type of the vehicle the permission for vehicle ignition will be given. Using of the license data for giving permission for vehicle movement is most advantageous. Interestingly the assistance system can eliminate the possibility of using of forged and stolen licenses by checking the license.

The system obtains the information of the driving applicant's finger print and verifies the information of the finger print included in the license according to the information in the database of the allowed/authorized people for driving the vehicle (specified by the owner 330) by the central processor of the vehicle, and in case of confirmation the system will give the permission for vehicle ignition.

The system has an intelligent chip, central processor, monitor, audio alert, GSM-GPS-GPRS module 106, printer 110 and central memory, which these circuits are designed so that after vehicle ignition the system will check all the traffic rules with functional parameters of driver 331 and dynamic parameters of vehicle when the vehicle is on or moving and in case of conflict, it will warn via the audio system, E-mail, SMS etc. and if the driver 331 doesn't pay attention the system will issue a fine (by thermal printer system) and simultaneously will notify traffic police 329. This online and instantaneous control of the vehicle regarding to traffic regulations (auto-control and management of traffic regulations or exclusive regulations of companies and organizations) is most favorable. Also all the traffic regulations and the coordinates of their applying extent, for all the roads and ways are available on the system central memory, and the processor will check the rules, which are valid at that point by means of coordinates are provided by GPS module 106 and will make decision. It should be noticed that at the beginning of setup, every time, the system will inquire from traffic police 329 for adaptation of major changes in maps and regulations, and if necessary or if there are new regulations and restrictions, the system will update itself and act accordingly to the new rules.

The system can be controlled in both centralized way and decentralized way by using of SMS and GPRS-GSM system, and the owner 330 can control all of the vehicle features by using of mobile phone or any type of GPRS signal transmission, and during car robbery the he/she can turn off or control the car by enter his/her own password and other user information. Circuits of the system are designed in such a way to transmit system data to the traffic police 329 as a centralized function and give them to the person's parents as a decentralized function.

This system has a reader device that is capable to read the information of the tags on all the traffic signs along the roads, bridges, tunnels, barriers etc., and the internal modules of the device reads the data of speed and other internal parameters of the vehicle and verifies them with obtained information of the road, and in case of any discrepancy give necessary warnings 220,221 and if the driver 331 pays no attention to the notifications, record the case of violation 219 and send it to traffic police 329 and other responsible agencies (together with information of vehicle and license of the vehicle driver 331).

The central system of the vehicle is equipped with a printer 110, a board and a processor that evaluates all the rules with current coordinates of the vehicle instantaneously and plays its specific message via an alarm immediately after the violation 219 and if the driver 331 pays no attention, it records the violation 219 in the name of the license holder/vehicle owner 330 and issues a fine.

While requesting for ignition, the vehicle checks the validity of the insurance card, vehicle card and vehicle inspection report by obtaining the information from insurance company 339 and inquiry from traffic police 329 and then gives the permission for driving. The system has the capability to obtain this information online and, for example, once during the validity period of the insurance card etc.

The system can stay in contact with the insurance system by using an embedded chipset and informs the driver 331 about the insurance validity period or takes action for its validity extension in proper time.

The system is also capable to void the vehicle inspection report when an accident happens, if necessary it also takes action to reserve time and place for the vehicle inspection. The automatic voidance of the vehicle inspection report during accidents or according to traffic officer's order is supported by the system. Also, the system of each vehicle records the information about its own violations 219 automatically and lets the traffic police 329 know.

The system can recognize the speed limit with respect to the read information from the traffic sign's transmitter or the internal map and process it regarding to its own speed, and in case of violation 219, records the report of the violation 219 and notifies the traffic police 329 about that, and informs the owner 330 via systems of audio warning 220,221, SMS, E-mail etc.

The system is capable to pay the traffic fines online, periodically or at a specific time by using of the bank account connected to the license as well as mobile phone credit and issues the receipt of the municipal services, daylight traffic plan, ticket reserving, park meter etc.

The system can obtain the warning and declarative information from traffic police 329 or other responsible agencies and inform the driver 331 about them (i.e. avalanche, landslide, traffic information, traffic limitations, roadside advertisements etc.).

The system is capable to decide about validity of the license type in the road and being allowed to drive with respect to the type of the vehicle and the time of the vehicle movement on the road by reading the information of the license and comparing the information of the sign, internal map and vehicle movement coordinates, and if there is a violation 219, record the case of violation 219 and notify the traffic police 329 (for example temporal and spatial limitations for heavy vehicles' movement or restrictions of license type B etc.).

The system is capable to check the places which have been defined as odd-even traffic or buses' special line or traffic plan by order of traffic police 329, by means of information received from intelligent chipsets of traffic signs or the intelligent map embedded in its own memory, and if the vehicle/driver 331 has committed a violation 219, issues a fine and notifies traffic police 329.

The system is capable to calculate the distance to a vehicle in front by connecting to the intelligent systems of the vehicle or separate radars and sensors, and with respect to the type of the vehicle, make a decision about time of movement (day or night) and the road type in case of the allowed speed, safe speed and distance to vehicle and barriers in front (with respect to vehicle speed), and if the vehicle/driver 331 has committed a violation 219, issue a fine or inform the traffic police stations 338. It should be noticed that the system can declare the allowed distance to facilitate the decision making of driver 331 for adjusting the speed and distance to the vehicle in front.

The system distinguishes the places of no-entry, no stop etc. via traffic signs or the coordinates in the map, and with respect to the coordinates obtained from its navigator. If a violation 219 occurs notifies the driver 331 and in case of violation 219 of that rule issues a fine. This applies for all the places, which are no parking, bus stop, along the road, squares etc.

The system is capable to distinguish being at toll-collection points 335 via GPS, GPRS or GSM, and pay amount of toll through its own payment systems without need of any installed physical structure in toll-collection gate or any personnel. The toll payment without any local hardware as well as the recognition of the toll-collection point is convenient, because less personnel and hardware is needed.

The system is capable to be in touch with insurance system by using an embedded chipset and informs the driver 331 about the validity of the insurance letter or makes some changes, such as extensions of new insurance letters.

The system is capable to recognize the driving time exceeding over a permissible time according to the law for the public vehicles or any type of vehicles and prevent from violation 219. If an image of the person has been stored in the license, the system is also able to compare it with live image received by camera and prevents from driving with licenses of others. The system gives the information about the violations 219 to traffic police 329.

The system is capable to identify the last driver 331 and in case of violations 219, which are subject to a fine issuance 222 by traffic officers or when the driver 331 isn't present at violation place, give the related information to the traffic officer via an embedded transmitter and a signal encrypted by public or private key, and record the violation 219 in the name of the driver 331 or the vehicle.

The system is also able to give all the movement events of the driver 331 or the vehicle such as speed and movement directions, from the beginning of travel time or before that. Advantageously, some of the latter travels, depending on a request, can be used when the vehicle is stopped by traffic officers or when an accident occurs etc.

The system is capable to apply all the regulations of special vehicles such as taxi, bus etc. by identifying the vehicle type and licenses of the driver/people and with an automatic comparison of specific rules based on license and vehicle.

The system is capable to recognize coordinates of a crossroad and, if the traffic light is red, receives the information submitted by the red traffic light and, if the driver 331 violates by crossing the red light, issues a fine. The system receives the duration of being red by receiving a signal from the traffic light, and displays it to the driver 331. Also depending on request or if the time extends or changes, the system can display the information of the light on the vehicle's monitor 109 with new updated information. Also the system is able to prevent from blocking the allowed right-turns and left-turns by receiving the coordinates and direction of vehicle movement and distinguishing the road and entry path, and to issue the permissions easily for allowed right-turns when the traffic light is red. Also vehicles confirm the reception of the signal themselves by sending a signal to the traffic light, whereby another system, installed on the traffic light, is able to obtain information of the rate of vehicle accumulation at a red light phase. This way the installed system decides for proper duration times of red, yellow and green light phases. Alternatively the installed system implements the proper solution by sending the information of vehicle accumulation to the traffic control center 336.

The system can identify the road, where the vehicle is currently located, and checks if the usage of the reverse gear is applicable. In case of using the reverse gear on a highway it records the violation 219.

The system determines the road by identifying the road to be a one-way as well as the direction of the vehicle movement, and if there is a violation 219 issues necessary warnings 220,221 and, in case of lack of attention, records the violation 219.

The system notifies the driver 331 regarding to the vehicle information and the information obtained from the road such as maximum height or weight of vehicle, and prevents from violation 219. The obtaining of the information of allowed height and weight for the road in accordance with traffic police's opinion from an internal map of the vehicle is advantageous.

According to determination of limit of traffic penalties for each person or each vehicle, the system is capable to prevent person driving/vehicle moving who/which violates this limit or informs the police 329 about the location of the offending vehicle. The system is capable to identify the last driver 331 and informs traffic police 329 about the related information by sending an encrypted signal to the part of the system that is accessible for traffic officer. In case of violations 219, which the driver 331 isn't present at the vehicle or stopping place, the system notifies the driver 331 by sending warning SMS or a notification about the penalty or vehicle detention, for example for offences like not stopping or when carrying by crane.

At special places like a police station 338 or a toll-collection point 335, a specific classification of violators and passing vehicles will be carried out, and vehicles of the violators of the traffic regulations will be classified and declared to the related police station 338 (e.g. roadside billboards).

The system is capable to warn the moving vehicle or passengers if the seat-belts aren't fastened by the driver 331 and other passengers of the vehicle according to the related regulations at the coordinates, and in case of lack attention issue a fine.

The system is capable to prevent from accidents by means of received information from a train etc. at level crossings.

The system has the capability to connect to the vehicle alarm and can call the numbers stored in its memory or send a warning SMS during the warning by car alarm by using of GSM and GPRS modules 106. The connection between car alarm and GPRS system is very effective.

The system is capable to display the information of its warnings 220,221 visually on the monitor 109 enabling the drivers 331, who are deaf or hearing impaired, to drive, and also declare the information about horns of the side vehicles visually for the driver 331 by its microphone sensor.

The system is capable to insure that the snow chains are connected to the vehicle via a chipset that is designed for snow chains, in particular in the roads where the usage of snow chains is mandatory (with respect to the time of obligation to use). If the driver 331 doesn't use the snow chains the necessary warnings 220,221 are given and in case of lack of attention it records the violation 219 and gives the specifications of the vehicle to traffic police 329 for stopping it.

The internal circuits of the system are designed in such a way to record the coordinates of the vehicle with distance travelled and compare this information with information of the vehicle ignition moment and if there is a conflict (of course by considering a balanced coefficient) the system goes into the towing determination or unauthorized interruption state. When the vehicle crashes for any reason it must be moved by the authorized tow vehicles to the parking or authorized repair services (or the offences which cause vehicle movement by crane), whereby these vehicles will have received the permission for their own systems for position changing. When igniting again the information of the vehicle registration plate and its password must have been obtained, otherwise the system records the violation 219 of unauthorized towing for the vehicle. Also this can prevent the main system of the vehicle to turn off, because if it has been reconnected, the system is faced with changes in vehicle distance travelled and in coordinates, and will send the information of the vehicle as a violator to traffic police 329.

A part of this system, in particular the vehicle-external device 328, may be at disposal of: ministries, public and private agencies and organizations such as traffic police 329, police 329 and military forces, insurance 339, emergency medical services, firefighting, taxi, bus, municipalities 343, real state registration, freightage services, authorized repair services and others who asked to use this system. The system is capable to make regular and periodic reports as textual, schematic and spreadsheets on related menus and sends it to persons' E-mails. Also, it has some abilities such as: controlling all the required facilities, service selling, system's software and database updates, traffic plan management and selling, vehicle parking places etc., sending coordinates and complete information of accident scene and full description of report with coordinates and speed and dynamic parameters of the vehicle before and at the accident time as well as images and the traffic officer's report for insurance companies 339, road assistance vehicles, traffic police 329 and other authorized organizations. Some part of the system may be located at car pricing centers and, through connecting to the vehicle, gives all the information, such as distance travelled, average movement on roads, average movement in cities, average movement in villages, average speed, average speed in streets, average speed in roads, report of changing main parts of engine, accident reports, accumulative report of vehicle offences and all the information that effects on price of the car to the experts. The system is able to price the vehicle by using its advanced internal algorithms based on artificial intelligence based techniques, car manufacturer information, its general system and the data of physical observations by the experts.

In summary, the assistance system for automated, intelligent management of traffic regulations is a system for surveillance on proper implementation of the traffic regulations in a transportation system, that acts by using hardware already installed on the vehicle and the tags installed on traffic signs and its internal intelligent map that includes all traffic rules with coordinates of applying extent of them. The system records all the actions of the vehicle like a Black box, and also controls all traffic rules in places which the vehicle passes and in case of violation 219 plays the necessary audio warnings 220,221 and sends the information of the vehicle, violation 219 and license of the violator to traffic police 329 at the same time. Also the system makes turning on and using of the vehicle to be subject to locating the valid and appropriate license with respect to vehicle type, so that the person while entering the vehicle put the license in specific place and after authentication the system starts moving.

### REFERENCE NUMERALS

101 Speaker
102 Power Supply
103 GPS/Galileo/GLONASS/QZSS receiver
104 Microphone
105 Central processing unit
106 GSM-GPRS-G3 Module
107 Fingerprint sensor
108 Smartcard reader module
109 Monitor
110 Printer
111 Antenna
212 Start
213 Inquiry of vehicle card
214 Inquiry of inspection report
215 Inquiry of vehicle insurance
216 Inquiry of driver's license
217 Comparison of rules with driver performance
218 Driver performance
219 Driver violation
220 First warning
221 Second warning
222 Issuance of a fine
223 Sending fine to the vehicle driver
224 Sending fine to the vehicle owner
225 Sending fine to the traffic police
226 Has first warning been given?
227 Has second warning been given?
328 Central server
329 Police/traffic police
330 Vehicle owner
331 Vehicle driver
332 Device installed on vehicle
333 System device installed on crossroads
334 Controlling system of the roads
335 Toll-collection point
336 Control center
337 Gas station
338 Traffic police station
339 Insurance agency/insurance company
340 Industries
341 Electronic government agencies
342 Bank
343 Municipalities
344 Ministry of roads
Y YES
N No
V Valid
I Invalid

1. Assistance system comprising a violation information recorder (332) in a vehicle for an automated recording of violation information (219) corresponding to the vehicle, wherein the assistance system is adapted to make the violation information (219) available to a vehicle-external device (328), in particular a central server (328), being controllable by a vehicle-external person (330), such as the owner (330) of the vehicle or the like, or an institution (329, 336, 337, 338, 339, 340, 341, 342, 343, 344), such as the traffic police (339), or the like.

2. Assistance system according to claim 1, wherein the assistance system is adapted to obtain warning (220,221) and/or declarative information from the vehicle-external device (328).

3. Assistance system according to one of the preceding claims, wherein the assistance system is adapted to check traffic rules with functional parameters of a vehicle driver (331) and dynamic parameters of the vehicle when the vehicle is moving, whereby a warning (220,221) for the vehicle driver (331) is generated, in particular by means of the audio system of the vehicle, in case the check reveals a violation (219).

4. Assistance system according to one of the preceding claims, wherein the assistance system is adapted to electronically read the license data of the vehicle driver (331) using a device of the car dashboard and ignite the engine of the vehicle in dependence on the validity of the license.

5. Assistance system according to the preceding claims 3 and 4, wherein the assistance system is adapted to check traffic rules and the type of the license in respect to the type of the vehicle.

6. Assistance system according to one of the preceding claims, wherein the assistance system is adapted to obtain finger print data of the vehicle driver (331) and verify the obtained finger print data with stored finger print data included in the license.

7. Assistance system according to one of the preceding claims, wherein the assistance system is adapted to check the validity of the car insurance (339) by an automated, preferably online, request to an institution upon vehicle ignition.

8. Assistance system according to claim 3, wherein the assistance system comprises a reader device adapted to read information from traffic signs and recognize traffic rules to check for possible violations (219).

9. Assistance system according to one of the preceding claims, wherein the assistance system is adapted to receive information from approaching trains in order to generate a warning (220,221) for the vehicle driver (331).

10. Assistance system according to claim 3, wherein the assistance system is adapted to check traffic rules by taking current coordinates of the vehicle into account.

11. Assistance system according to one of the preceding claims, wherein the assistance system is adapted to recognize a marked area and an allowance status of the marked area based on additionally supplied data.

12. Assistance system according to one of the preceding claims, wherein the assistance system is adapted to prevent a person having committed a violation (219) from driving or moving the vehicle.

13. Assistance system according to one of the preceding claims, wherein the assistance system is connected to a vehicle alarm system to take a warning measure, such as send a warning SMS Or initiate a phone call.

14. Assistance system according to one of the preceding claims, wherein the assistance system is adapted to intelligently observe the traffic and record violations (219) of other vehicles to take preventive steps, such as warn the other vehicles for too fast or too slow movement.

15. Assistance system according to one of the preceding claims, wherein the assistance system is controllable in a centralized and a decentralized way.

16. Assistance system according to one of the preceding claims, wherein the assistance system is adapted to immobilize the vehicle in case of a violation (219).

17. Assistance system according to one of the preceding claims, wherein the assistance system comprises an encrypted internal memory for the storage and recording of finger print data and license data.

18. Assistance system according to one of the preceding claims, wherein the assistance system is adapted to be in touch with an institution (329, 336, 337, 338, 339, 340, 341, 342, 343, 344), such as an insurance agency (339).

19. Assistance system according to claim 18, wherein the assistance system is adapted to communicate with the institution (329, 336, 337, 338, 339, 340, 341, 342, 343, 344), such as contacting the insurance agency (339) and take action for the insurance validity extension on time.

20. Assistance system according to one of the preceding claims, wherein the assistance system is adapted give notice of the warnings (220,221) visually or acoustically.

21. Assistance system according to one of the preceding claims, wherein the assistance system is adapted to notify the driver (331) regarding the vehicle information and the information obtained from the road to prevent violation (219).

22. Assistance system according to one of the preceding claims, wherein the assistance system, in particular the vehicle-external device (328), is adapted to supply data access to the vehicle-external person (330), such as a driver (331) of a bus or taxi or other authorized persons, and/or to the institution, such as a ministry (344), public or private agency, traffic police (329), police (329), military forces, insurance agency (339), emergency medical services, firefighters, municipality (343), real estate registration, freightage services or repair service.

23. Assistance system according to one of the preceding claims, wherein the assistance system, in particular the vehicle-external device (328), is adapted to void the vehicle inspection report when an accident happened.

24. Assistance system according to one of the preceding claims, wherein the assistance system is adapted to recognize the speed limit and compare the vehicle speed to the recognized speed limit.

25. Assistance system according to one of the preceding claims, wherein the assistance system is adapted to notify the driver (331) about speed limits, warnings (220,221) and declarative information of the road when entering the road.

26. Assistance system according to one of the preceding claims, wherein the assistance system is adapted to recognize the coordinates of a traffic light and to access traffic light information.

27. Assistance system according to one of the preceding claims, wherein the assistance system is enabled to distinguish places of no entry from places with allowed access.

28. Assistance system according to one of the preceding claims, wherein the assistance system is adapted to disable reverse gear in dependence on the road type.

29. Assistance system according to one of the preceding claims, wherein the assistance system is adapted to apply regulations of special vehicles, such as taxi or bus, by identifying the vehicle type and the license type.

30. Assistance system according to one of the preceding claims, wherein the assistance system comprises an intelligent cruise control enabled to declare the allowed speed and the distance to the vehicle in front.

31. Assistance system according to one of the preceding claims, wherein the assistance system is adapted to warn the vehicle driver (331) or other passenger of the vehicle if the seat belts are not fastened.

32. Assistance system according to one of the preceding claims, wherein the assistance system is adapted to record the driving time and to recognize driving times exceeding the allowed time.

33. Assistance system according to one of the preceding claims, wherein the assistance system is adapted to communicate the last vehicle driver (331) to the owner (330) of the vehicle or to the institution (329, 336, 337, 338, 339, 340, 341, 342, 343, 344), such as the traffic police (329).

34. Assistance system according to claim 33, wherein the assistance system is adapted to send driver (331) related information to the vehicle-external device (328).

35. Assistance system according to one of the preceding claims, wherein the assistance system is adapted to record the coordinates of the vehicle along with the distance travelled and compare the current coordinates at ignition with the last recorded coordinates before ignition for conflicts, whereby if a conflict is found the assistance system enters the towing determination or unauthorized interruption state.

36. Assistance system according to one of the preceding claims, wherein the assistance system is adapted to ensure that snow chains are connected to the vehicle.

37. Assistance system according to one of the preceding claims, wherein the assistance system is adapted to classify and declare violators at selected locations, such as a police station (338) or a toll-collection point (335).

38. Assistance system according to one of the preceding claims, wherein the assistance system is adapted to recognize a toll-collection point (335) as such via GPS, GPRS or GSM and initiate the toll payment.

39. Assistance system according to one of the preceding claims, wherein the assistance system is adapted to pay tolls and/or traffic fines online via the internet or the mobile phone credit.
